(19) United States
(12) Patent Application Publication
(10) Pub. No.: US 2015/0248347 A1
(43) Pub. Date: Sep. 3, 2015

(54) CONTENT PROVIDING APPARATUS AND METHOD, AND COMPUTER PROGRAM PRODUCT

(71) Applicant: Kabushiki Kaisha Toshiba, Minato-ku (JP)

(72) Inventors: Mika MINEMATSU, Fuchu (JP); Hiroyuki Aizu, Yokohama (JP)

(73) Assignee: Kabushiki Kaisha Toshiba, Minato-ku (JP)

(21) Appl. No.: 14/602,359

(22) Filed: Jan. 22, 2015

(30) Foreign Application Priority Data
Feb. 28, 2014 (JP) 2014-039638

(51) Int. Cl. G06F 12/02

(52) U.S. Cl. CPC G06F 12/0284; G06F 12/023; G06F 2212/251

(57) ABSTRACT

According to an embodiment, a content providing apparatus includes: a receiving unit that receives a request for content from a communication terminal; an obtaining unit that obtains the content according to the request; a rendering unit that renders the content and generates rendering information; a storage that stores therein the rendering information of the content; a judging unit that judges, according to the content, whether a storage area, which stores therein the rendering information, of the storage is overwritable; a allocating unit that allocates the storage area as an overwritable or non-overwritable storage area, according to the judgment result; a determining unit that determines whether to change the content, and determines a change method used when the content is changed; a content changing unit that changes the content, using the rendering information, according to the change method; and a transmitting unit that transmits the changed content to the communication terminal.

### CROSS-REFERENCE TO RELATED APPLICATIONS

This application is based upon and claims the benefit of priority from Japanese Patent Application No. 2014-039638, filed on Feb. 28, 2014; the entire contents of which are incorporated herein by reference.

### FIELD

Embodiments described herein relate generally to a content providing apparatus and method, and a computer program product.

### BACKGROUND

There is known a technique in which data such as the results of arithmetic processing by a CPU is cached in a storage so that the data can be used when the data is required again. The results of arithmetic processing by the CPU include, for example, rendering information of video and a still image rendered by the CPU. In addition, there is known a technique related to a method for overwriting or deleting data in order to effectively use a storage with limited space.

However, an efficient use of the storage areas of the storage and a reduction in the load of the process of storing data cannot be achieved.

### BRIEF DESCRIPTION OF THE DRAWINGS

FIG. 1 is a diagram illustrating an example of a configuration of a content providing apparatus of a first embodiment;

FIG. 2 is a diagram illustrating an example of the storage areas of a storage of the first embodiment that store rendering information;

FIG. 3 is a diagram illustrating an example of a change for when an SVG image is replaced with a PNG image;

FIG. 4 is a diagram illustrating an example of a change made to designate the position and size of an image;

FIG. 5 is a flowchart illustrating an example of a method for providing content of the first embodiment;

FIG. 6 is a flowchart illustrating a method for determining a method for changing web content of the first embodiment;

FIG. 7 is a diagram illustrating an example of a configuration of a content providing apparatus of a second embodiment;

FIG. 8 is a flowchart illustrating an example of a method for providing content of the second embodiment;

FIG. 9 is a diagram illustrating an example of a configuration of a content providing apparatus of a third embodiment;

FIG. 10 is a flowchart illustrating an example of a method for providing content of the third embodiment; and

FIG. 11 is a diagram illustrating an example of a hardware configuration of the content providing apparatuses of the first to third embodiments.

### DETAILED DESCRIPTION

According to an embodiment, a content providing apparatus includes a receiving unit, an obtaining unit, a rendering unit, a storage, a judging unit, an allocating unit, a determining unit, a content changing unit, and a transmitting unit. The receiving unit receives a request for content from a communication terminal. The obtaining unit obtains the content, according to the request. The rendering unit renders the content and generates rendering information. The storage stores therein the rendering information of the content. The judging unit judges, according to the content, whether a storage area, which stores therein the rendering information of the content, of the storage is overwritable. The allocating unit allocates the storage area as an overwritable storage area or a non-overwritable storage area, according to a result of the judgment by the judging unit. The determining unit determines whether to change the content, and determines a change method used when the content is changed. The content changing unit changes the content, using the rendering information of the content, according to the change method. The transmitting unit transmits the content changed by the content changing unit to the communication terminal.

Various embodiments will be described in detail below with reference to the accompanying drawings. A description in the following embodiments is made of the case in which web content is provided as content.

### First Embodiment

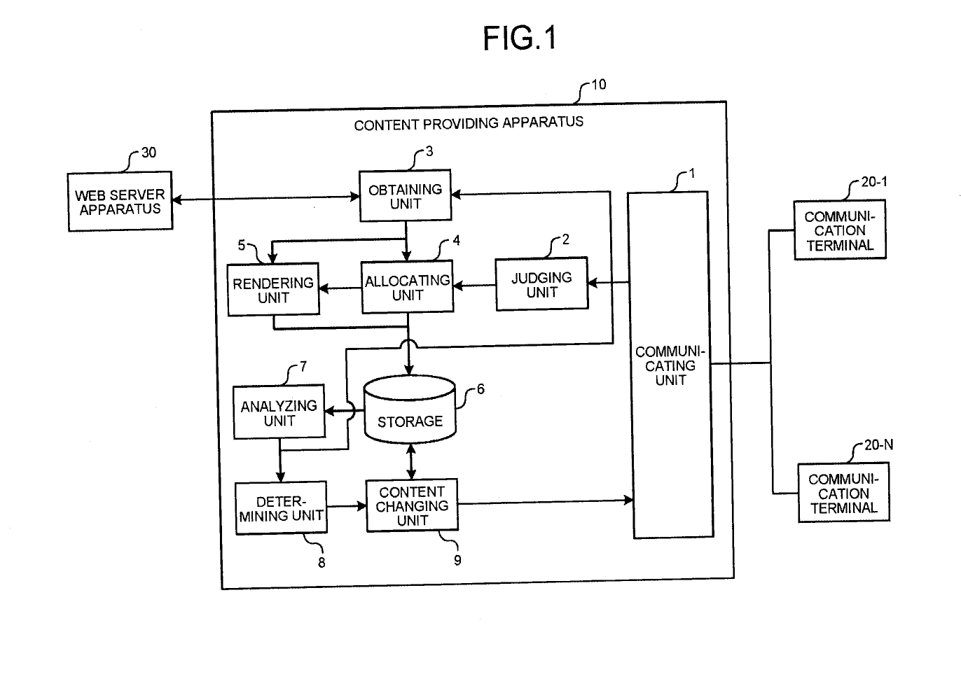

FIG. 1 is a diagram illustrating an example of a configuration of a content providing apparatus 10 of a first embodiment. The content providing apparatus 10 of the first embodiment includes a communicating unit 1, a judging unit 2, an obtaining unit 3, an allocating unit 4, a rendering unit 5, a storage 6, an analyzing unit 7, a determining unit 8, and a content changing unit 9.

The communicating unit 1 receives a request for web content from each of a communication terminal 20-1, . . . , and a communication terminal 20-N (N is an integer greater than or equal to 2). When the communication terminal 20-1, . . . , and the communication terminal 20-N do not need to be distinguished from each other, they are hereinafter simply referred to as communication terminals 20. The request for web content includes identification information of the web content. The identification information is information that identifies the web content on a network. The identification information is, for example, a URL (Uniform Resource Locator). The method for receiving, by the communicating unit 1, requests for web content from the communication terminals 20 may be any. For example, the content providing apparatus 10 may be registered as a proxy server in the browser settings of a communication terminal 20, and when a browser of the communication terminal 20 requests for web content, the communicating unit 1 may receive a request for the web content from the communication terminal 20. Namely, the communicating unit 1 may receive from the communication terminal 20 an HTTP (Hyper Text Transfer Protocol) request including a URL, as a request for web content. The communicating unit 1 inputs the received request for web content to the judging unit 2 and the obtaining unit 3.

The communicating unit 1 receives communication terminal information from the communication terminal 20. The communication terminal information is information indicating the performance of the communication terminal 20 such as communication speed, computing power, screen resolution, and screen size and the states of the communication terminal 20 such as packet loss rate and remaining battery level. The timing at which the communicating unit 1 receives communication terminal information may be any. For example, communication terminal information may be received at the same time as a request for web content. Alternatively, the content providing apparatus 10 may request the communication terminal 20 for communication terminal information as necessary, and obtain the communication termination information from the communication terminal 20. The communicating unit 1 inputs the communication terminal information to the determining unit B.

The communicating unit 1 transmits to the communication terminal 20 web content that has been changed as necessary in processing (described later) by the content changing unit 9.

The judging unit 2 accepts the request for web content from the communicating unit 1. The judging unit 2 judges, according to the identification information such as a URL, whether rendering information of the web content can be overwritten. The rendering information of the web content is generated by the rendering unit 5 (described later) rendering the web content. The judging unit 2, for example, holds in advance a list of the URLs of web content whose rendering information is not allowed to be overwritten. Then, the judging unit 2 judges that rendering information of web content identified by identification information of web content identified by a URL that coincides with any URL existed in the list is cannot be overwritten.

The obtaining unit 3 accepts the request for web content from the communicating unit 1. The obtaining unit 3 obtains the web content from a web server apparatus 30, according to the request for web content. The obtaining unit 3 obtains the web content by referring to, for example, a URL included in an HTTP request, as the identification information of the web content. The obtaining unit 3 inputs the obtained web content to the allocating unit 4 and the rendering unit 5. The content providing apparatus 10 may also serve as the web server apparatus 30.

The allocating unit 4 accepts from the judging unit 2 the result of the judgment as to whether the rendering information can be overwritten, which is made according to the identification information. The allocating unit 4 also accepts from the obtaining unit 3 the web content obtained according to the identification information. The allocating unit 4 stores the web content in the storage 6. The allocating unit 4 allocates a storage area, which stores the rendering information of the web content, of the storage 6, as an overwritable storage area or a non-overwritable storage area, according to the result of the judgment by the judging unit 2. The allocating unit 4 inputs information indicating the storage area that stores the rendering information of the web content, to the rendering unit 5.

The allocating unit 4 may allocate one of a plurality of storage areas of the storage 6 divided in advance. The allocating unit 4 may dynamically allocate a storage area with a size required upon allocation of a storage area. In the case of dynamic allocation, the allocating unit 4 may, for example, dynamically allocate a storage area with an optimal size, according to UA (User Agent) information of an HTTP request received by the communicating unit 1 from the communication terminal 20.

Here, the case in which the allocating unit 4 is implemented by a program will be specifically described using as an example the case in which the OS (Operating System) of the content providing apparatus 10 is Linux (registered trademark). In the case of Linux (registered trademark), a program that implements the allocating unit 4 can be implemented using, for example, a shared library and LD_PRELOAD environment variable. When functions with the same name between an original shared library set in LD_PRELOAD and a shared library which is loaded automatically are defined, the content of the function defined in the original shared library is executed. Hence, for example, the malloc function which is a function for allocating a storage area and the free function for deallocating the storage area are defined in the original shared library. Namely, a program that implements the allocating unit 4 is implemented such that the allocation and deallocation of the storage area of the storage 6 are performed by the original shared library. With this, when a browser (rendering unit 5) starts up with the original shared library set in LD_PRELOAD, the allocation and deallocation of a storage area for rendering web content by the browser can be replaced with the allocation and deallocation of a storage area of the storage 6.

When only allocation of a storage area for rendering web content needs to be replaced with the malloc function in the original shared library, for example, a malloc function in the original shared library is created such that an allocation is changed only when the size of the storage area is larger than a threshold value. When only deallocation of a storage area for rendering web content needs to be replaced with the free function in the original shared library, for example, a free function in the original shared library is created such that a deallocation is changed only when the address of the storage area corresponds to the storage area of the storage 6.

The rendering unit 5 accepts the web content from the obtaining unit 3. The rendering unit 5 also accepts from the allocating unit 4 the information indicating the storage area that stores the rendering information of the web content. The rendering unit 5 renders the web content and generates rendering information, and stores the rendering information in the storage area of the storage 6 specified by the allocating unit 4. The rendering unit 5 is, for example, a browser.

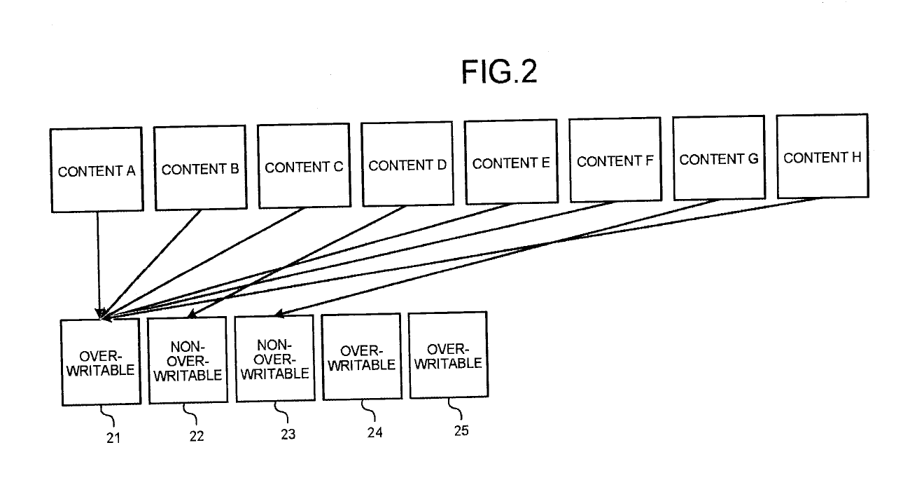

The storage 6 stores therein the rendering information of the web content rendered by the rendering unit 5, in an overwritable storage area or a non-overwritable storage area. The storage 6 also stores therein the web content obtained by the obtaining unit 3. FIG. 2 is a diagram illustrating an example of the storage areas of the storage 6 of the first embodiment that store rendering information. In the example of FIG. 2, the storage 6 is divided into five storage areas 21 to 25. The storage area 21, the storage area 24, and the storage area 25 are overwritable storage areas. The storage areas 22 and 23 are non-overwritable storage areas. The example of FIG. 2 is an example of the case in which pieces of rendering information of content A, content B, content C, content E, content F, and content H are allocated to the overwritable storage area 21. For example, in the case in which the rendering information of the content A is already stored in the storage area 21, when the communicating unit 1 receives a request for the content B from a communication terminal 20, the allocating unit 4 overwrites the rendering information of the content A in the storage area 21 with the rendering information of the content B.

The size of the storage areas 21 to 25 is, for example, a size appropriate to 1024×768 pixels or 1280×800 pixels which are generally used as the resolution of a display. For example, when the resolution of a display of a communication terminal 20 is 1024×768 pixels and 32 bpp (bits per pixel), a 3 MB storage area is required to display web content on the communication terminal 20.

The analyzing unit 7 analyzes the web content stored in the storage 6. The analyzing unit 7 analyzes the web content to, for example, specify whether the web content contains a description of processing which uses a scripting language (hereinafter, referred to as “script information”). In addition, the analyzing unit 7 estimates the processing load of the web content. The analyzing unit 7 estimates the processing load of the web content by, for example, the number of lines of the source code (HTML file, etc.) of the web content or the number of lines of a description of processing using a scripting language contained in the web content. Alternatively, for example, periods of time required for the rendering unit 5 to render pieces of web content may be measured and the rendering periods of time for respective pieces of web content may be stored in the content providing apparatus 10, and the analyzing unit 7 may estimate the processing load of web content using the rendering periods of time. In addition, the analyzing unit 7 further concretely specifies processing which uses a scripting language. The analyzing unit 7, for example, specifies that the processing using a scripting language is an image display processing using SVG (Scalable Vector Graphics). The analyzing unit 7 inputs the results of the analysis of the web content to the determining unit 8.

The determining unit 8 accepts the results of the analysis from the analyzing unit 7. The determining unit 8 also accepts the above-described communication terminal information from the communicating unit 1. The determining unit 8 determines, according to the communication terminal information, whether to change the web content. The determining unit 8 also determines a concrete method for changing the web content. The determining unit 8 inputs the change method to the content changing unit 9.

An example of a method for determining, by the determining unit 8, a method for changing the web content will be first described.

For example, the determining unit 8 may obtain communication terminal information through the communicating unit 1. When the communication terminal information satisfies a predetermined condition (hereinafter, referred to as a “first condition”), the determining unit 8 may determine to change the web content to rich web content or not to change the web content. When the communication terminal information does not satisfy the first condition, the determining unit 8 may determine to change the web content in such a manner to reduce the processing load on a communication terminal 20 that displays the web content. The first condition is an arbitrary combination of conditions about the performance of the communication terminal 20 such as communication speed, computing power, screen resolution, and screen size and the states of the communication terminal 20 such as remaining battery level and packet loss rate. Changing the web content to rich web content refers to an improvement of the quality or amount of data of the web content. The web content is changed to rich web content by, for example, increasing the resolution or size of an image contained in the web content.

In addition, for example, the determining unit 8 may transmit a probe packet to the communication terminal 20 through the communicating unit 1 to calculate, as communication terminal information, packet loss rate between the content providing apparatus 10 and the communication terminal 20. When the packet loss rate is smaller than a first threshold value, the determining unit 8 may determine to change the web content to rich web content or not to change the web content. When the packet loss rate is greater than or equal to the first threshold value, the determining unit 8 may determine to change the web content in such a manner to reduce the processing load of the communication terminal 20 that displays the web content.

Next, an example of a method for changing web content will be described. First, the case of reducing the processing load of a communication terminal 20 that displays web content will be described. The determining unit 8 determines a method for reducing the processing of a communication terminal 20 that displays web content, according to the processing load of the web content.

The determining unit 8, for example, changes the method for reducing the process, by setting a plurality of threshold values. As an example of the method for reducing the processing by setting a plurality of threshold values, the case in which web content is a parallax website will be specifically described. The parallax website is a website that represents a visual effect such as animation by changing an image in accordance with scrolling of a browser. The determining unit 8, for examples, sets two threshold values: a threshold value T1 and a threshold value T2 (T1>T2). When the number of lines of the source code (HTML file, etc.) of the web content is greater than T1, the determining unit 8 determines to convert script information so as to fix an image used for animation. When the number of lines of the source code (HTML file, etc.) of the web content is less than or equal to T1 but is greater than T2, the determining unit 8 determines to convert the script information so as to reduce the frequency of changing the position of the image.

When the web content is to be changed to rich web content in the case of the web content being a parallax website, the determining unit 8 determines to convert the script information such that the image moves more smoothly, for example.

When, for example, the browser of the communication terminal 20 does not support SVG, the determining unit 8 determines to change the web content such that an SVG image is replaced with a PNG image. The determining unit 8 specifies whether the browser of the communication terminal 20 supports SVG, by referring to UA (User Agent) information in an HTTP request received from the communication terminal 20, for example.

The content changing unit 9 accepts the change method from the determining unit 8. The content changing unit 9 changes the web content, according to the change method determined by the determining unit 8. The content changing unit 9 inputs the changed web content to the communicating unit 1. When the determining unit 8 determines not to change the web content, the content changing unit 9 inputs the web content to the communicating unit 1 without changing the web content. The communicating unit 1 transmits the web content changed as necessary by the content changing unit 9 to the communication terminal 20.

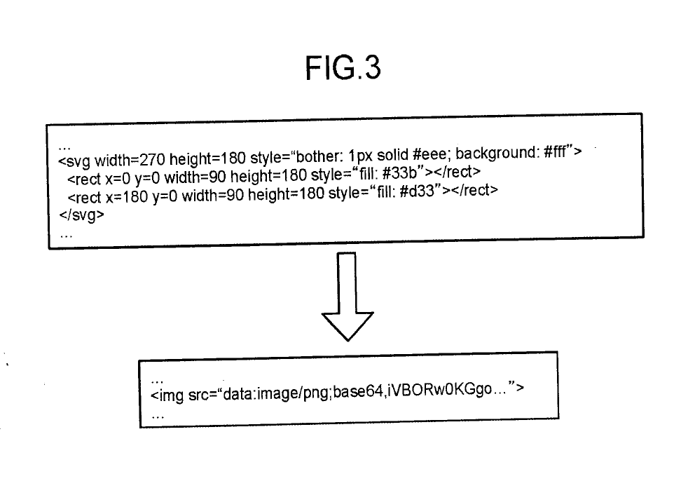

FIG. 3 is a diagram illustrating an example of a change for when an SVG image is replaced with a PNG image. The SVG image in FIG. 3 is image data representing the national flag of France. In the case of the example of FIG. 3, the content changing unit 9 renders web content and thereby generates rendering information including an SVG image in a storage area of the storage 6. Then, the content changing unit 9 creates a PNG image from the SVG image, using the rendering information. Then, the content changing unit 9 replaces the SVG element of the web content with an IMG element that refers to the created PNG image. Note that the content changing unit 9 may change a compression scheme for the created PNG image or perform a scale-up/down process on the created PNG image, according to the performance or states of the communication terminal 20 identified by the above-described communication terminal information.

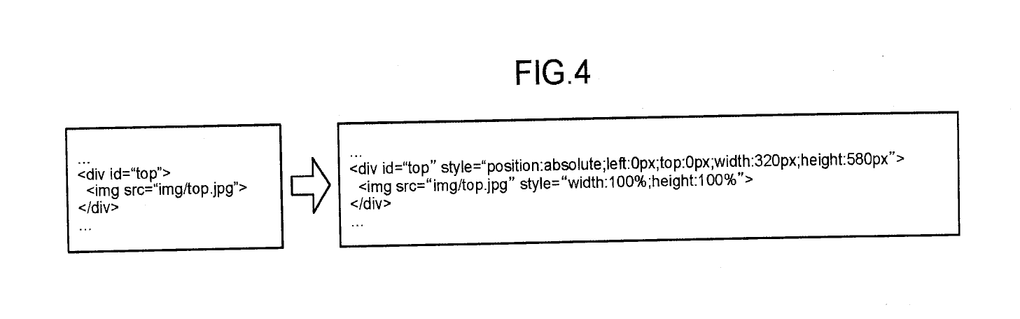

FIG. 4 is a diagram illustrating an example of a change made to designate the position and size of an image. The example of FIG. 4 is an example of the case in which the content changing unit 9 changes web content such that the position and size of “top.jpg” are designated using the style attribute. This can eliminate the need for the communication terminal 20 to perform layout computation for “top.jpg”, enabling to reduce the processing load on the communication terminal 20 that displays “top.jpg” contained in the web content. The position and size of an HTML element such as “top.jpg” can be obtained using, for example, getBoundingRect API. The content changing unit 9 changes the web content such that the position and size obtained from the web content by getBoundingRect API are designated.

The above-described judging unit 2 judges that identification information of web content such as that illustrated in FIG. 3 cannot be overwritten. This is because the rendering information of the web content in FIG. 3 includes an SVG image and thus the SVG image can be used without rendering the SVG image again. The above-described judging unit 2 judges that identification information of web content such as that illustrated in FIG. 4 can be overwritten. This is because the rendering information of the web content in FIG. 4 is not necessary when the position and size of an HTML element are obtained.

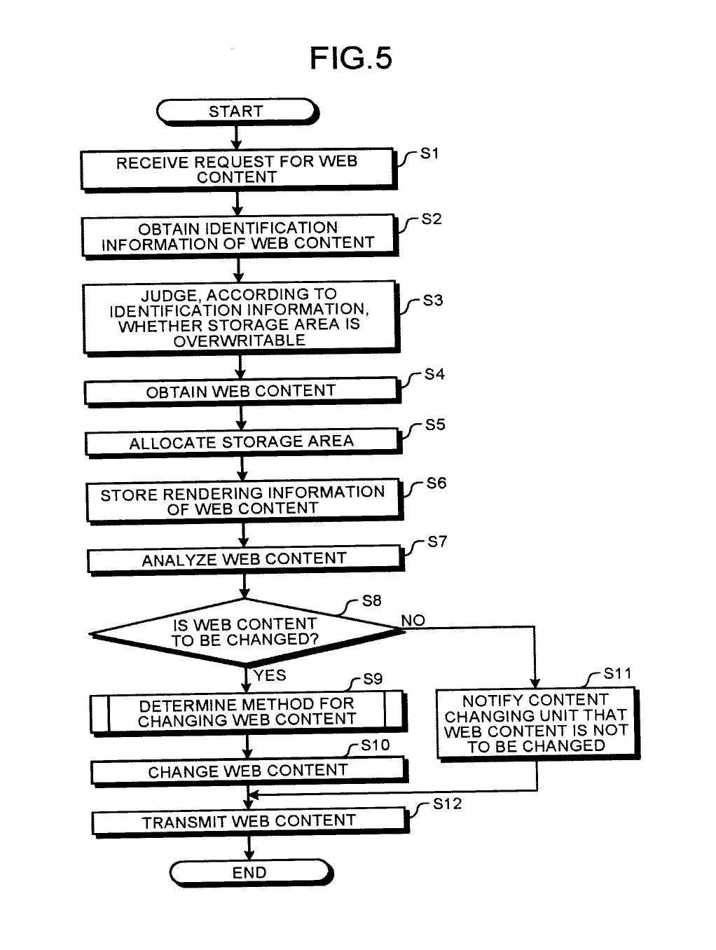

Next, a method for providing content of the first embodiment will be described. FIG. 5 is a flowchart illustrating an example of a method for providing content of the first embodiment. The communicating unit 1 receives a request for web content from a communication terminal 20 (step S1). Then, the judging unit 2 obtains identification information such as a URL from the request for web content (step S2). Then, the judging unit 2 judges whether a storage area of the storage 6 that stores rendering information of the web content identified by the identification information can be overwritten (step S3). The judging unit 2, for example, holds in advance a list of the URLs of web content whose rendering information is not allowed to be overwritten. Then, the judging unit 2 judges that rendering information of web content identified by identification information of web content identified by a URL that coincides with any URL existed in the list cannot be overwritten.

Then, the obtaining unit 3 obtains the web content from the web server apparatus 30, according to the request for web content (step S4).

Then, the allocating unit 4 allocates, according to the result of the judgment by the judging unit 2, the storage area of the storage 6 that stores the rendering information of the web content obtained by the obtaining unit 3, as an overwritable storage area or a non-overwritable storage area (step S5). In addition, the allocating unit 4 stores the web content obtained by the obtaining unit 3. Then, the rendering unit 5 renders the web content obtained by the obtaining unit 3 and generates rendering information, and stores the rendering information in the storage area allocated by the allocating unit 4 (step S6). Since all pieces of rendering information of web content that can be overwritten can be rendered in the same storage area by step S5 and S6, the storage areas of the storage 6 of the content providing apparatus 10 can be efficiently used.

Then, the analyzing unit. 7 analyzes the web content stored in the storage 6 (step S7). The determining unit 8 determines, according to the results of the analysis by the analyzing unit. 7, whether to change the web content (step SB).

If the web content is not to be changed (No at step S8), the determining unit 8 notifies the content changing unit 9 that the web content is not to be changed (step S11). The content changing unit 9 transmits the web content to the communication terminal 20 through the communicating unit 1 without changing the web content (step S12).

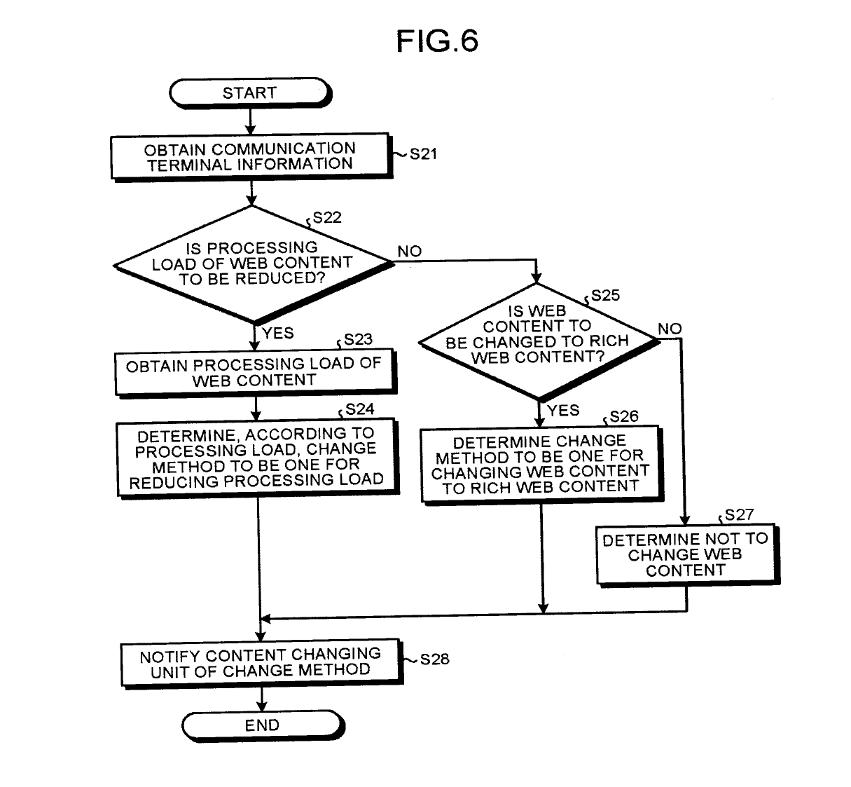

If the web content is to be changed (Yes at step S8), the determining unit 8 determines a method for changing the web content (step S9). Here, a method for determining, by the determining unit 8, a method for changing the web content will be described with reference to FIG. 6.

FIG. 6 is a flowchart illustrating a method for determining a method for changing web content of the first embodiment. The determining unit 8 obtains the above-described communication terminal information (step S21). Then, the determining unit 8 determines, according to the communication terminal information, whether to reduce the processing load of the web content (step S22).

If the processing load is to be reduced (Yes at step S22), the determining unit 8 obtains the processing load of the web content which is estimated by the analyzing unit 7 analyzing the web content (step S23). Then, the determining unit 8 determines, according to the processing load of the web content, a method for changing the web content for reducing the processing load (step S24). For example, when the web content is a parallax website, the determining unit 8 determines to convert script information such that an image used for animation is fixed.

If the processing load is not to be reduced (No at step S22), the determining unit. 8 determines, according to the communication terminal information, whether to change the web content to rich web content (step S25). If the web content is to be changed to rich web content (Yes at step S25), the determining unit 8 determines a change method for changing the web content to rich web content (step S26). For example, when the web content is a parallax website, the determining unit 8 determines to convert the script information such that the image moves more smoothly.

If the web content is not to be changed to rich web content (No at step S25), the determining unit 8 determines not to change the web content (step S27).

Then, the determining unit 8 notifies the content changing unit 9 of the change method (step S28).

Referring back to FIG. 5, the content changing unit 9 then changes the web content, according to the change method determined by the determining unit 8 (step S10). Then, the communicating unit 1 transmits the web content changed by the content changing unit 9 to the communication terminal 20 (step S12).

As described above, according to the content providing apparatus 10 of the first embodiment, by controlling, according to identification information of web content, the storage of rendering information of the web content stored in the storage 6, the storage areas of the storage 6 can be efficiently used and the load of processing of storing the rendering information can be reduced.

Although control of the storage of web content itself has not been explicitly described; the content providing apparatus 10 may also perform the same storage control on the web content as that for rendering information of web content. Namely, the content providing apparatus 10 may determine the authority of a storage area that stores web content, in accordance with the authority of a storage area that stores rendering information of the web content.

### Second Embodiment

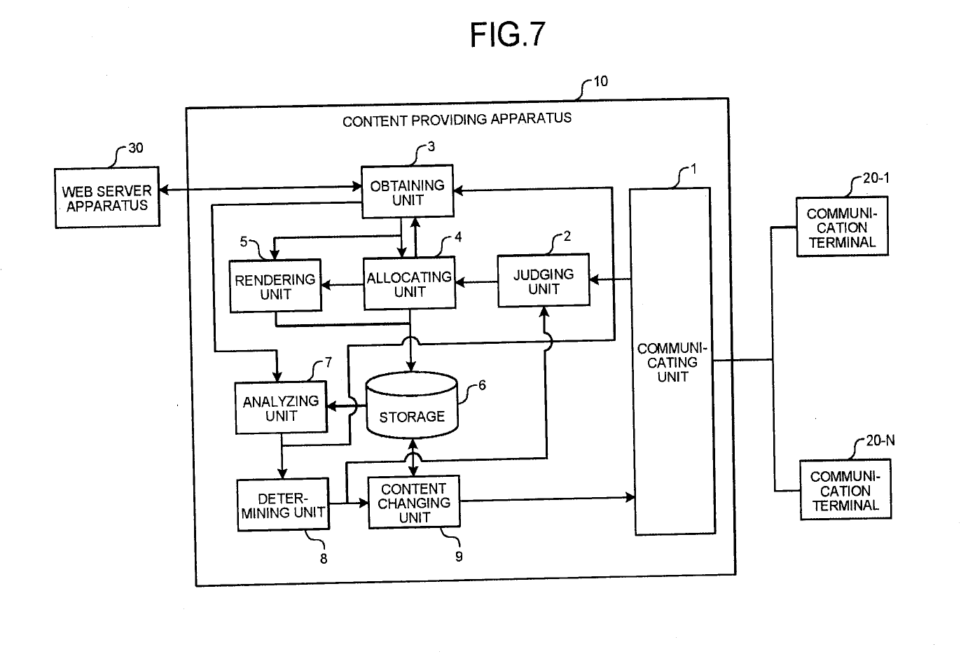

Next, a second embodiment will be described. In the second embodiment, the case will be described in which a judging unit 2 judges, according to a method for changing web content which is determined by a determining unit 8, whether a storage area of a storage 6 that stores rendering information of web content is overwritable. FIG. 7 is a diagram illustrating an example of a configuration of a content providing apparatus 10 of the second embodiment. The content providing apparatus 10 of the second embodiment includes a communicating unit 1, a judging unit 2, an obtaining unit 3, an allocating unit 4, a rendering unit 5, a storage 6, an analyzing unit 7, a determining unit 8, and a content changing unit 9. The configuration of the content providing apparatus 10 of the second embodiment is the same as that of the first embodiment. In a description of the second embodiment, differences from the first embodiment will be described.

The communicating unit 1 inputs a received request for web content to the obtaining unit 3. The obtaining unit 3 judges whether the web content is already stored in the storage 6, by referring to cache information in the allocating unit 4. Here, the cache information will be described.

The cache information is information indicating the states of the storage areas of the storage 6. The cache information includes, for example, the size of a storage area that stores rendering information of web content and is set to be non-overwritable; the start address of the storage area for the rendering information of the web content; identification information (a URL, etc.) of web content whose rendering information has been rendered; the size of a storage area that stores web content; and the start address of the storage area for the web content.

When the web content requested by a communication terminal 20 is not stored in the storage 6, the obtaining unit 3 obtains the web content from a web server apparatus 30. The obtaining unit 3 inputs the obtained web content to the allocating unit 4 and the rendering unit 5. When the web content requested by the communication terminal 20 is stored in the storage 6, the obtaining unit 3 notifies the analyzing unit 7 of cache information of the web content.

The allocating unit 4 accepts the web content from the obtaining unit 3. The allocating unit 4 stores the web content in the storage 6. In addition, the allocating unit 4 newly allocates a storage area of the storage 6 that stores rendering information of the web content, as a non-overwritable storage area. Then, the allocating unit 4 updates the cache information with the information in the newly allocated storage area. When the judging unit 2 judges later that the storage area is overwritable, the allocating unit 4 changes the storage area to “overwritable” and updates the cache information. The allocating unit 4 inputs information indicating the storage area that stores the rendering information of the web content, to the rendering unit 5.

The rendering unit 5 accepts the web content from the obtaining unit 3. The rendering unit 5 also accepts from the allocating unit 4 the information indicating the storage area that stores the rendering information of the web content. The rendering unit 5 renders the web content and generates rendering information, and stores the rendering information in the storage area of the storage 6 that is designated by the allocating unit 4.

The storage 6 stores the rendering information of the web content rendered by the rendering unit 5, in the non-overwritable storage area. When the judging unit 2 judges that the storage area is overwritable, the storage area of the storage 6 is changed to “overwritable”. The storage 6 stores therein the web content obtained by the obtaining unit 3.

The analyzing unit 7 analyzes the web content in the storage 6. The determining unit 8 accepts the results of the analysis from the analyzing unit 7. The determining unit 8 also accepts the above-described communication terminal information from the communicating unit 1. The determining unit 8 determines, according to the communication terminal information, whether to change the web content. In addition, the determining unit 8 also determines a concrete method for changing the web content. The determining unit 8 inputs the change method to the judging unit 2 and the content changing unit 9.

The judging unit 2 accepts the method for changing the web content from the determining unit 8. The judging unit 2 judges, according to the method for changing the web content, whether the rendering information of the web content can be overwritten.

The method for judging, by the judging unit 2, whether the rendering information of the web content can be overwritten, according to the method for changing the web content may be any. The judging unit 2 may judge, according to whether to change the web content, whether the rendering information of the web content can be overwritten.

When, for example, the web content is to be changed, the judging unit 2 sets the storage area for the rendering information of the web content to a non-overwritable storage area. Namely, the authority of the storage area for the rendering information of the web content is left in its original state obtained upon allocation (non-overwritable).

When, for example, the web content is not to be changed, the judging unit 2 sets the storage area for the rendering information of the web content to an overwritable storage area. Namely, the authority of the storage area for the rendering information of the web content is changed from the state obtained upon allocation (non-overwritable) to “overwritable”.

The judging unit. 2 may further judge, according to the concrete method for changing the web content, whether the rendering information of the web content can be overwritten.

When, for example, the rendering information of the web content includes an image rendered based on script information of the web content, the judging unit 2 sets the storage area for the rendering information of the web content to a non-overwritable storage area. Namely, the authority of the storage area for the rendering information of the web content is left in its original state obtained upon allocation (non-overwritable).

When, for example, the rendering information of the web content does not include an image rendered based on script information of the web content, the judging unit 2 sets the storage area for the rendering information of the web content to an overwritable storage area. Namely, the authority of the storage area for the rendering information of the web content is changed from the state obtained upon allocation (non-overwritable) to “overwritable”.

When the authority of the storage area for the rendering information is changed to “overwritable”, the judging unit 2 inputs to the allocating unit 4 the result of the judgment indicating the storage area for the rendering information, the authority of which is to be changed to “overwritable”. When the allocating unit 4 accepts the result of the judgment made by the judging unit 2, the allocating unit 4 changes the authority of the storage area of the storage 6, based on the result of the judgment.

The content changing unit 9 accepts the change method from the determining unit 8. The content changing unit 9 changes the web content, according to the change method determined by the determining unit 8. The content changing unit 9 inputs the changed web content to the communicating unit 1. When the determining unit 8 determines not to change the web content, the content changing unit 9 inputs the web content to the communicating unit 1 without changing the web content. The communicating unit 1 transmits the web content changed as necessary by the content changing unit 9 to the communication terminal 20.

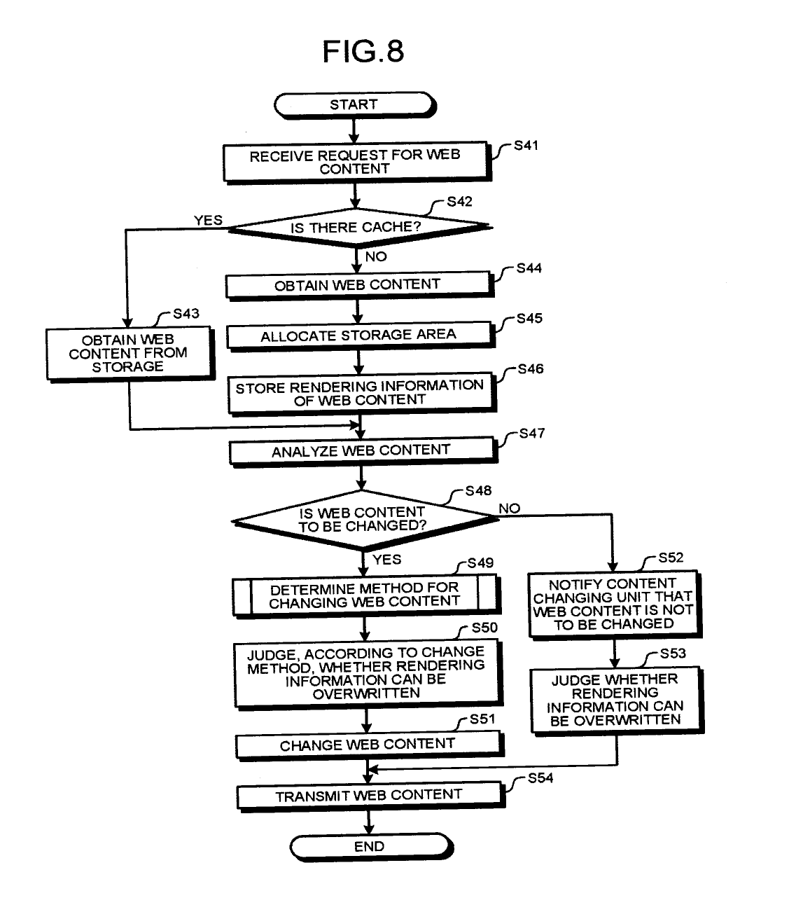

Next, a method for providing content of the second embodiment will be described. FIG. 8 is a flowchart illustrating an example of a method for providing content of the second embodiment. The communicating unit 1 receives a request for web content from a communication terminal 20 (step S41). Then, the obtaining unit 3 judges whether the web content requested by the communication terminal 20 is already stored in the storage 6, by referring to cache information in the allocating unit 4 (step S42). Namely, the obtaining unit 3 judges whether there is a cache for the web content requested by the communication terminal 20.

If there is a cache (Yes at step S42), the analyzing unit 7 obtains the web content from the storage 6 (step S43).

If there is no cache (No at step S42), the obtaining unit 3 obtains the web content from the web server apparatus 30 (step S44). Then, the allocating unit 4 allocates a storage area of the storage 6 that stores rendering information of the web content, as a non-overwritable storage area (step S45). The allocating unit 4 stores the web content obtained by the obtaining unit 3. Then, the rendering unit 5 renders the web content obtained by the obtaining unit 3 and generates rendering information, and stores the rendering information in the storage area allocated by the allocating unit 4 (step S46).

Then, the analyzing unit 7 analyzes the web content in the storage 6 (step S47). The determining unit 8 determines, according to the results of the analysis by the analyzing unit 7, whether to change the web content (step S48).

If the web content is not to be changed (No at step S48), the determining unit 8 notifies the content changing unit 9 that the web content is not to be changed (step S52). Then, the judging unit 2 judges whether the rendering information of the web content can be overwritten (step S53). When, for example, the web content is to be changed, the judging unit 2 sets the storage area for the rending information of the web content to a non-overwritable storage area. The content changing unit 9 transmits the web content to the communication terminal 20 through the communicating unit 1 without changing the web content (step S54).

If the web content is to be changed (Yes at step S48), the determining unit 8 determines a method for changing the web content (step S49). The method for changing the web content is the same as that in the first embodiment and thus a description thereof is omitted (see FIG. 6).

Then, the judging unit 2 judges, according to the method for changing the web content, whether the rendering information of the web content can be overwritten (step S50). When, for example, the rendering information of the web content includes an image rendered based on script information of the web content, the judging unit 2 sets the storage area for the rendering information of the web content to a non-overwritable storage area. Namely, when the method for changing the web content is, for example, a change where an image created by script information is changed to an image file reference format (the case of FIG. 3, etc.), the storage area for the rendering information of the web content is set to a non-overwritable storage area.

Then, the content changing unit 9 changes the web content, according to the change method determined by the determining unit 8 (step S51). Then, the communicating unit 1 transmits the web content changed by the content changing unit 9 to the communication terminal 20 (step S54).

As described above, according to the content providing apparatus 10 of the second embodiment, by controlling, according to a method for changing web content, the storage of rendering information of the web content stored in the storage 6, the storage areas of the storage 6 can be efficiently used and the load of the process of storing the rendering information can be reduced.

### Third Embodiment

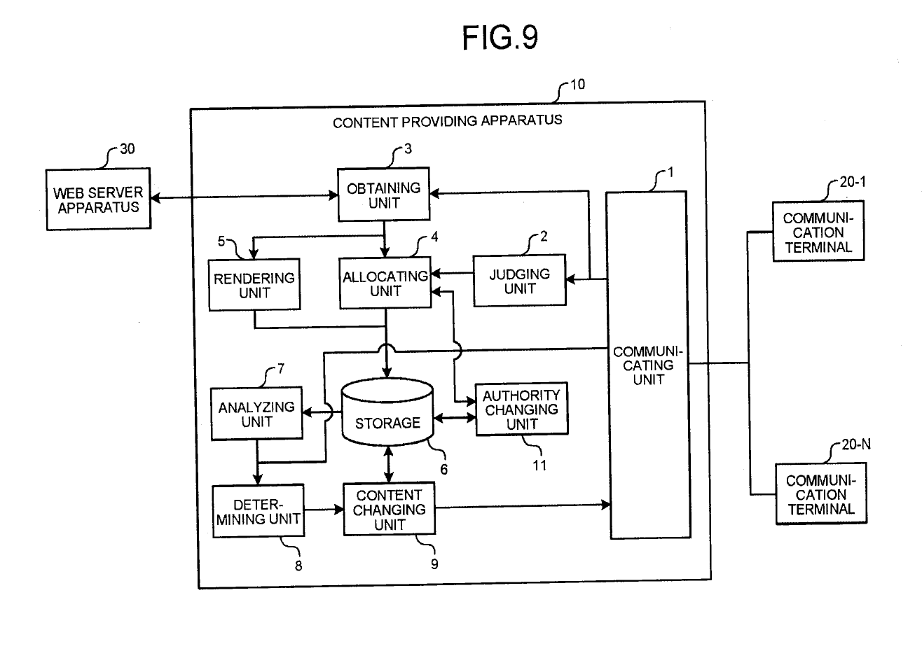

Next, a third embodiment will be described. The third embodiment describes storage control performed when all of the storage areas of the storage 6 have become non-overwritable. FIG. 9 is a diagram illustrating an example of a configuration of a content providing apparatus 10 of the third embodiment. The content providing apparatus 10 of the third embodiment includes a communicating unit 1, a judging unit 2, an obtaining unit 3, an allocating unit 4, a rendering unit 5, a storage 6, an analyzing unit 7, a determining unit 8, a content changing unit 9, and an authority changing unit 11. The configuration of the content providing apparatus 10 of the third embodiment is such that the authority changing unit 11 is added to the configuration of the first embodiment. In a description of the third embodiment, differences from the first embodiment will be described.

The judging unit 2 accepts a request for web content from the communicating unit 1. The judging unit 2 judges, according to identification information such as a URL, whether rendering information of the web content can be overwritten. The allocating unit 4 accepts from the judging unit 2 the result of the judgment as to whether the rendering information can be overwritten which is made according to the identification information. In addition, the allocating unit 4 accepts from the obtaining unit 3 web content obtained according to the identification information.

The allocating unit 4 judges whether there is a storage area for storing the rendering information of the obtained web content. Namely, the allocating unit 4 judges, by the rendering information of the newly obtained web content, whether the storage 6 has an overwritable storage area. When the storage 6 does not have an overwritable storage area, the allocating unit 4 inputs a notification indicating a change to the authority of a storage area, to the authority changing unit 11.

When all of the storage areas of the storage 6 have become non-overwritable storage areas, the authority changing unit 11 changes a non-overwritable storage area to an overwritable storage area, according to the web content. The method for changing, by the authority changing unit 11, a non-overwritable storage area to an overwritable storage area may be any.

The authority changing unit 11 may change a non-overwritable storage area to an overwritable storage area, according to the number of accesses to the web content or the frequency of access to the web content, for example. The frequency of access is the number of accesses to the web content per unit time. The unit time is, for example, one hour, one day, or one week.

The authority changing unit 11 may change a non-overwritable storage area to an overwritable storage area, according to the expiry date of web content, for example. This is because overwriting is performed starting from web content having a high possibility of being changed. In this case, the authority changing unit 11 may change a non-overwritable storage area to “overwritable”, starting from web content with a small value of the Expires header in an HTTP header indicating the expiry date of the web content, or web content whose URL has a random variable.

In order to perform overwriting starting from, for example, web content whose re-rendering is easy, the authority changing unit 11 may change a non-overwritable storage area to “overwritable”, starting from web content with a small number of HTML elements or web content with a short rendering time.

The number of pieces of web content, of which the authorities of storage areas for rendering information are simultaneously changed from “non-overwritable” to “overwritable” by the authority changing unit 11, may be any. The authority changing unit 11 may, for example, provide a threshold value of the number of non-overwritable storage areas, and change all of non-overwritable storage areas exceeding the threshold value to “overwritable”. Alternatively, the authority changing unit 11 may, for example, change storage areas to “overwritable” one by one every time an overwritable storage area becomes necessary.

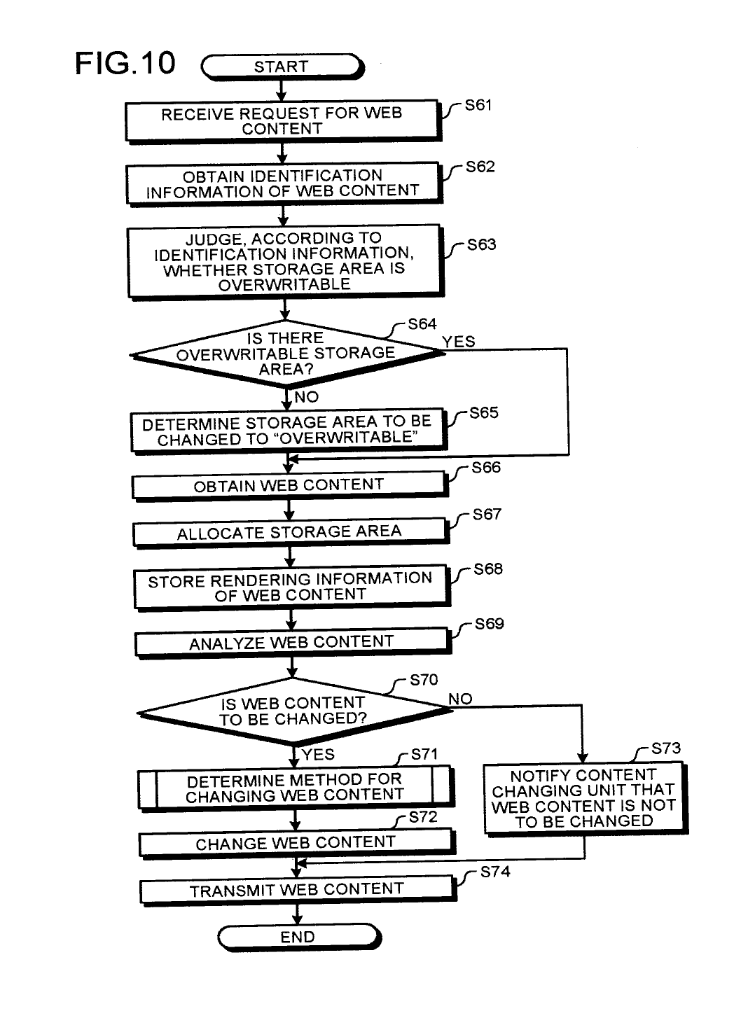

Next, a method for providing content of the third embodiment will be described. FIG. 10 is a flowchart illustrating an example of a method for providing content of the third embodiment. The communicating unit 1 receives a request for web content from a communication terminal 20 (step S61). Then, the judging unit 2 obtains identification information such as a URL from the request for web content (step S62). Then, the judging unit 2 judges whether a storage area of the storage 6 that stores rendering information of the web content identified by the identification information is overwritable (step S63). The judging unit 2, for example, holds in advance a list of the URLs of web content whose rendering information cannot be overwritten. Then, the judging unit 2 judges that rendering information of web content identified by identification information of web content identified by a URL that coincides with any URL existed in the list cannot be overwritten.

Then, the allocating unit 4 judges, by the rendering information of the newly obtained web content, whether the storage 6 has an overwritable storage area (step 264).

If the storage 6 has an overwritable storage area (Yes at step S64), the processing proceeds to step S66.

If the storage 6 does not have an overwritable storage area (No at step S64), the authority changing unit 11 changes, according to the web content, a non-overwritable storage area that stores the rendering information of the web content to an overwritable storage area (step S65). The authority changing unit 11 changes a non-overwritable storage area to an overwritable storage area, according to the number of accesses to the web content or the frequency of access to the web content, for example.

The obtaining unit 3 obtains the web content from the web server apparatus 30, according to the request for web content (step S66).

Step S67 to S74 are the same as step S5 to S12 of the first embodiment in FIG. 5 and thus a description thereof is omitted.

As described above, according to the content providing apparatus 10 of the third embodiment, when an overwritable storage area is not available, a change to “overwritable” is made starting from rendering information of web content, the storage of which is likely to provide only a small effect. With this, while the storage areas of the storage 6 are effectively used, the load of the processing of storing rendering information can be reduced.

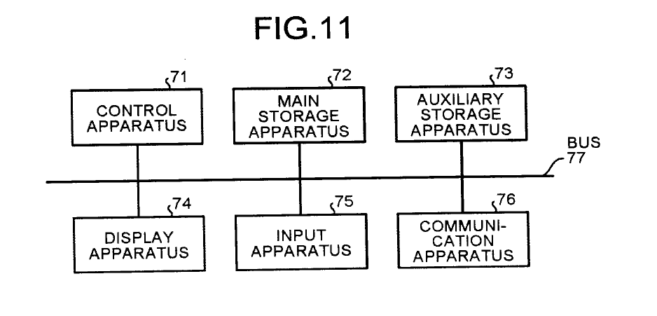

Finally, an example of a hardware configuration of the content providing apparatuses 10 of the first to third embodiments will be described. FIG. 11 is a diagram illustrating an example of a hardware configuration of the content providing apparatuses 10 of the first to third embodiments. The content providing apparatuses 10 of the first to third embodiments include a control apparatus 71, a main storage apparatus 72, an auxiliary storage apparatus 73, a display apparatus 74, an input apparatus 75, and a communication apparatus 76. The control apparatus 71, the main storage apparatus 72, the auxiliary storage apparatus 73, the display apparatus 74, the input apparatus 75, and the communication apparatus 76 are connected to each other through a bus 77. The content providing apparatuses 10 may be any apparatus having the above-described hardware configuration. For example, the content providing apparatuses 10 are server apparatuses.

The control apparatus 71 executes a program read from the auxiliary storage apparatus 73 to the main storage apparatus 72. The main storage apparatus 72 is a memory such as a ROM or a RAM. The auxiliary storage apparatus 73 is an HDD or the like. The above-described storage 6 corresponds to at least one of the main storage apparatus 72 and the auxiliary storage apparatus 73. The display apparatus 74 displays, for example, the state of the content providing apparatus 10. The input apparatus 75 accepts an operation input from a user. The communication apparatus 76 is an interface used by the content providing apparatus 10 to communicate with the communication terminals 20.

A program executed by the content providing apparatuses 10 of the first to third embodiments is provided as a computer program product, stored in a computer-readable storage medium, such as a CD-ROM, a memory card, a CD-R, or a DVD (Digital Versatile Disk), as an installable or executable format file.

Alternatively, a program executed by the content providing apparatuses 10 of the first to third embodiments may be provided such that the program is stored on a computer connected to a network such as the Internet, and downloaded via the network. Alternatively, a program executed by the content providing apparatuses 10 of the first to third embodiments may be provided via a network such as the Internet without downloading the program.

Alternatively, a program of the content providing apparatuses 10 of the first to third embodiments may be provided such that the program is pre-installed in a ROM or the like.

A program executed by the content providing apparatuses 10 of the first and second embodiments has a module configuration including the above-described functional blocks (the communicating unit 1, the judging unit 2, the obtaining unit. 3, the allocating unit 4, the rendering unit 5, the analyzing unit 7, the determining unit 8, and the content changing unit 9). A program executed by the content providing apparatus 10 of the third embodiment has a module configuration including the above-described functional blocks (the communicating unit 1, the judging unit 2, the obtaining unit 3, the allocating unit 4, the rendering unit 5, the analyzing unit 7, the determining unit 8, the content changing unit 9, and the authority changing unit 11). For the actual hardware of the functional blocks, by the control apparatus 71 reading a program from a storage medium and executing the program, the functional blocks are loaded onto the main storage apparatus 72. Namely, the functional blocks are generated on the main storage apparatus 72.

Note that some or all of the above-described units (the communicating unit 1, the judging unit 2, the obtaining unit 3, the allocating unit 4, the rendering unit 5, the analyzing unit 7, the determining unit 8, the content changing unit 9, and the authority changing unit 11) may be implemented by hardware such as an IC (Integrated Circuit), instead of being implemented by software.

As described above, according to the first to third embodiments, by controlling, according to web content, the storage of rendering information of the web content stored in the storage 6, the storage areas of the storage 6 can be efficiently used and the load of the process of storing data can be reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A content providing apparatus comprising:
a receiving unit that receives a request for content from a communication terminal;
an obtaining unit that obtains the content, according to the request;
a rendering unit that renders the content and generates rendering information;
a storage that stores therein the rendering information of the content;
a judging unit that judges, according to the content, whether a storage area, which stores therein the rendering information of the content, of the storage is overwritable;
an allocating unit that allocates the storage area as an overwritable storage area or a non-overwritable storage area, according to a result of the judgment by the judging unit;
a determining unit that determines whether to change the content, and determines a change method used when the content is changed;
a content changing unit that changes the content, using the rendering information of the content, according to the change method; and
a transmitting unit that transmits the content changed by the content changing unit to the communication terminal.

2. The apparatus according to claim 1, wherein the judging unit judges whether the storage area is overwritable, according to identification information which identifies the content.

3. The apparatus according to claim 1, wherein, when the determining unit determines to change the content, the judging unit sets the storage area to a non-overwritable storage area.

4. The apparatus according to claim 3, wherein the judging unit further judges, according to the change method, whether the storage area of the storage is overwritable.

5. The apparatus according to claim 1, further comprising an authority changing unit that changes, according to the content, the non-overwritable storage area to the overwritable storage area when all of storage areas of the storage have become non-overwritable storage areas.

6. The apparatus according to claim 5, wherein the authority changing unit changes the non-overwritable storage area to the overwritable storage area, according to the number of accesses to the content or frequency of access to the content.

7. The apparatus according to claim 5, wherein the authority changing unit changes the non-overwritable storage area to the overwritable storage area, according to an expiry date of the content.

8. A content providing method comprising:
receiving, by a receiving unit, a request for content from a communication terminal;
obtaining, by an obtaining unit, the content according to the request;
rendering, by a rendering unit, the content and generating rendering information;
storing, in a storage, the rendering information of the content;
judging, by a judging unit, whether a storage area, which stores therein the rendering information of the content, of the storage is overwritable, according to the content;
allocating, by an allocating unit, the storage area as an overwritable storage area or a non-overwritable storage area, according to a result of the judgment made in the judging;
determining, by a determining unit, whether to change the content, and determining a change method used when the content is changed;
changing, by a content changing unit, the content using the rendering information of the content, according to the change method; and
transmitting, by a transmitting unit, the content changed in the changing to the communication terminal.

9. A computer program product comprising a computer-readable medium containing a computer program that causes a computer including a storage that stores therein rendering information to function as:
a receiving unit that receives a request for content from a communication terminal;
an obtaining unit that obtains the content, according to the request;
a rendering unit that renders the content and generates the rendering information;
a judging unit that judges, according to the content, whether a storage area, which stores therein the rendering information of the content, of the storage is overwritable;
an allocating unit that allocates the storage area as an overwritable storage area or a non-overwritable storage area, according to a result of the judgment by the judging unit;
a determining unit that determines whether to change the content, and determines a change method used when the content is changed;
a content changing unit that changes the content, using the rendering information of the content, according to the change method; and
a transmitting unit that transmits the content changed by the content changing unit to the communication terminal.
